(19) United States
(12) Patent Application Publication
(10) Pub. No.: US 2001/0053696 A1
(43) Pub. Date: Dec. 20, 2001

(54) Communication apparatus

(76) Inventors: Radhakrishna Pillai Raghavan Pillai, Singapore (SG); Maitreya Ranganath, Singapore (SG); Rahul Agrawal, Sunny Vale, CA (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/800,372

(22) Filed: Mar. 6, 2001

(30) Foreign Application Priority Data
Mar. 9, 2000 (SG) SG200001265-8

(51) Int. Cl. H04Q 7/20

(52) U.S. Cl. 455/445; 455/403

(57) ABSTRACT

Communication apparatus is disclosed comprising a network of interconnected components 200-250 having a fixed network portion and at least one wireless network portion, a communication route between a source terminal and a destination terminal being configurable through the network via at least some of the components and a route and location manager 100 arranged to calculate at least one said route, the manager having database means 110, 120 including route-relevant information of the fixed network portion and of the or each wireless network portion. Methods of calculating and modifying multicast routes using the apparatus are also disclosed.

### BACKGROUND AND FIELD OF THE INVENTION

This invention relates to communication apparatus, more particularly to communication apparatus for calculating a route.

In network communications, route determination is required for many operations such as setting up of a connection, modifying an existing connection, calculation of a new segment for a multicast tree and handoff. A typical call setup procedure with given end points (source and destination), includes a determination of the possible paths or routes between the end points and selection of an optimal route to transfer the data. The calculation of the optimal route is based on an optimality criterion. The best route can be one that gives the shortest path between the source and the destination (less number of hops), the least congested path or can be a path that is optimal as defined by the network. There may be many possible best paths depending on the optimality criterion and the constraints.

Quality of Service (QoS) is becoming an increasingly important factor in routing, particularly for real-time multi-media applications which demand explicit QoS guarantees. QoS routing augments the calculation of the route by including the QoS in the optimization criterion or by putting QoS as one of the constraints. In either case, the QoS plays an important role in finding the optimal route.

Routing in wireless Asynchronous Transfer Mode (ATM) networks which involves routing of calls to and/or from wireless terminals is performed by a route being calculated using a route manager, which has details of the fixed network including details of access point of each wireless network. Each wireless network has a location information database which has details of the actual location of each wireless terminal. Since the wireless terminals are mobile, the actual point of attachment of the terminal to the fixed network can change depending upon its location. To calculate the route, it is necessary for the route manager to query the location databases of the wireless networks of the caller and called parties to determine the actual location of the parties and then to calculate the optimal route based on the optimality criterion. This can cause significant network traffic which can be a problem in small and medium sized networks.

A further disadvantage of conventional routing is that the calculation of a route is performed using a single optimality criterion. The inventors have found that such an approach can be sub-optimal as, for example, there may be different QoS requirements for fixed and wireless portions of the route. This is particularly so when considering bandwidth availability. For wireless links, the available bandwidth is generally less than for fixed links, so that the setting of a connection across a combination of fixed and wireless links often cannot be met at a single high bandwidth QoS requirement. Furthermore, the algorithm used for route calculation and the signalling protocol used for setting up the route are linked, leading to inflexibility.

It is an object of the invention to provide communication apparatus which alleviates at least one of the aforementioned problems of the prior art.

### SUMMARY OF THE INVENTION

According to the invention in a first aspect, there is provided a communication apparatus comprising a network of interconnected components having a fixed network portion and at least one wireless network portion, a communication route between a source terminal and a destination terminal being configurable through the network via at least some of the components and a route and location manager arranged to calculate at least one said route, the manager having database means including route-relevant information of the fixed network portion and of the or each wireless network portion.

The route and location manager of the described embodiment of the invention provides collocated route and location information enabling a faster calculation of an optimal route, as the time spent on getting the location information is reduced. The route and location manager makes the routing decision simpler and faster for small and medium sized mobile networks and further makes the location update centralized which is also easier to handle for small and medium sized networks. The centralized route and location manager has an open interface which clearly separates the internal route calculation algorithm(s) from the signalling protocol used to access the route information so that any protocol, which supports the open interface, can call the route and location manager for route computation.

The route and location manager further provides flexibility in choosing the route calculation algorithm and allows support for different QoS descriptors for wired and wireless links.

The route and location manager furthermore provides the same address space for mobile and non-mobile end terminals and hence no special addressing mechanism for the mobile end terminals is required. The manager distinguishes between the mobile and fixed end terminals on the basis of the existence of an entry in a location database. If a terminal is registered with the location database, then the terminal is mobile and is assumed to be active.

According to the invention in a second aspect, there is provided a method of adding a further destination to a multicast connection tree between a source and a plurality of destinations comprising the steps of:

a. calculating a set of routes from the source to the further destination without any Quality of Service constraint,

b. selecting the optimal route from the set of routes,

c. calculating a make segment to be added to the existing multicast tree by eliminating the part from the optimal route which is common to the already existing multicast tree, to leave the segment

d. calculating a set of segment routes with a Quality of Service constraint; and

e. selecting the optimal segment route from the set and adding the segment route to the multicast tree.

### BRIEF DESCRIPTION OF THE DRAWINGS

An embodiment of the invention will now be described, by way of example, with reference to the accompanying drawings, in which:

FIG. 1 is a schematic diagram of an embodiment of the invention;

FIG. 2 illustrates a typical scenario for end-to-end route calculation;

### DETAILED DESCRIPTION OF THE PREFERRED EMBODIMENT

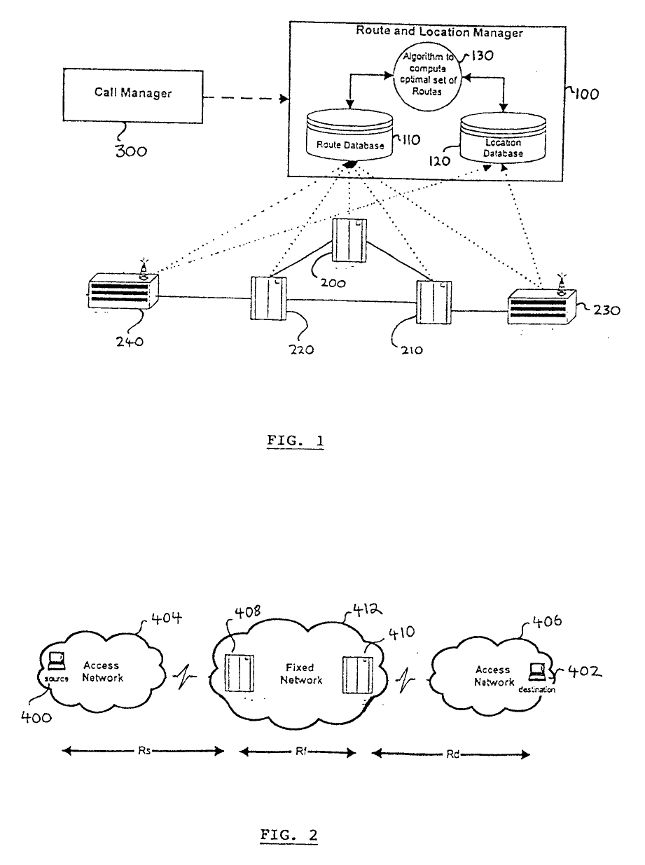

As shown in FIG. 1, the communication apparatus of the described embodiment of the invention includes a combined route and location manager 100 as its principal element. The manager 100 is connected to a communication network including network components such as public switches 200, 210, 220 of a fixed network and cellular base stations or access points 230, 240 of respective mobile networks which are connected together by communication links shown by solid lines. The manager 100 is further connected to a signalling entity hereinafter referred to as a call manager 300 which processes call requests from terminals connected/attached to the network and issues route setting instructions to the components of the network.

The route and location manager 100 includes two databases: a route database 110 and a location database 120 and a processor 130.

The route database 110 contains route-relevant information concerning the fixed network, such as the link and node topology, access points of mobile network cellular stations 230, 240 and Quality of Service (QoS) information for nodes and links. The connections between the manager 100 and the network components allow the route database 110 to be updated on a real-time basis with changes in the route-relevant information.

The location database 120 contains the location information of the mobile terminals of the cellular stations 230,240 and QoS information for the wireless connections from the cellular stations to mobile terminals in each station location. The connections between the manager 100 and the cellular stations 230, 240 allow the location database 120 to be updated on a real-time basis with the current location of any mobile terminal and changes in wireless QoS.

The processor 130 extracts information from the databases 110, 130 in response to a request for a route from call manager 300 and processes the information using any suitable algorithm to compute an optimal set of routes from source to destination in the following way:

1. The calling party (the source), sends a signalling message to the call manager 300 indicating a wish to establish a connection with another party (the destination) with a certain wireline and/or wireless QoS.

2. The call manager calls the route and location manager to get a list of routes to the destination, satisfying the QoS requirements. This list is computed by the route and location manager and output to the call manager.

3. Once the list of routes to the destination is available to the call manager, the call manager selects one route from the list. The route contains a set of links from source to destination connecting the switches and the access points (in case of the wireless links). If no route can be found in the list, the call is dropped and a failure is reported to the source.

4. The call manager then initiates the signalling to the switches in the chosen route. The switches are contacted to reserve the required QoS for links in the route.

5. Once the route has been set, a successful call connection signal is sent to the destination and the source to start transmitting the data.

A typical route calculation by the manager 100 is illustrated in FIG. 2. In this example, both the source 400 and destination 402 nodes are mobile and are within the access networks 404, 406 of respective cellular stations connected at respective access points 408, 410 to fixed network 412.

The route and location manager determines that the source 400 has an entry in the location database (since it is mobile). The access point 408 of the fixed network is found from the entry. A set Rₛ of routes ordered with respect to optimality criterion is then calculated by applying a generic algorithm ƒ(source, destination, QoS) between the source 400 (source) and access point 408 (destination).

The access point 410 of the mobile destination is found in the same way and the set R_{d} of routes ordered with respect to optimality criterion is calculated by applying a generic algorithm g(source, destination, QoS) between access point 410 (source) and the destination node 402 (destination).

The set of routes R_{f} ordered with respect to optimality criterion is then calculated by applying a generic algorithm h(source, destination, QoS) between the access points 408, 410 .

The end to end route R between the source and the destination is a function F (R_{f}, Rₛ, R_{d}) of R_{f}, Rₛ and R_{d} where F is any suitable function for combining the ordered sets of routes to provide a set R of ranked routes.

Mathematically: ∀×∈R, ×∈(R_{f}∪Rₛ∪R_{d}).

If either or both of the source and destination is not mobile, the respective set of routes Rₛ, R_{d}. is/are calculated as part of the fixed set of routes R_{f}.

The described embodiment, by applying the algorithm(s) on a segmented basis between source and destination allows different factors, for example different QoS requirements for fixed and wireless links, to be taken into account for different segments of the route and for optimal routes for each segment to be calculated.

Route selection algorithms f, g and h can be the same or different and can be freely chosen from any suitable algorithm depending upon the optimality criterion desired.

The route and location manager has an open interface, to make use of open signalling protocols, allowing route requests from any number of separate call managers which support open signalling to be processed. This provides a clear separation of the signalling protocols from the algorithms used internally by the route and location manager giving flexibility.

The route and location manager also has particular application in calculating a multicast route or rerouting a multicast connection. When the same piece of information is to be distributed among various destinations, having a separate connection from the source to each destination is inefficient. Instead a single connection is provided from the source (called a root) to the last common point between any two or more destinations and the information is then distributed from that point onwards to the destinations (called leaves). The resulting structure is termed a multicast tree and the use of a multicast tree can save a lot of bandwidth and other network resources in extreme cases.

To compute a multicast route, the call manager 300:

1. Sets up the first branch of the multicast route between the source and one destination using the procedure described above.

2. Calls the route and location manager with QoS parameter as null for a further destination. The route and location manager returns a set of routes, which may or may not satisfy a QoS constraint and thus supply topology information of the network.

3. Selects the most optimal route from the set of routes.

4. Calculates the new segment (a “make” segment) to be added to the multicast tree. This segment can be computed by eliminating the part from the most optimal route which is common to the multicast tree. Mathematically, if the route from the set of routes is R, and the existing multicast tree is represented by T then, the segment S is given by:

X∈S, ×∉(R∩T)

5. The call manager receives the QoS route for the segment S from the route and location manager by specifying the point of intersection of the segment S with the multicast tree, the further destination and the QoS. If the output of the Route and Location Manager is a null set, then step 3 is repeated for the next most optimal route in the set of routes R. Otherwise the output of the route and location manager contains the required segment to be added to the multicast tree and this is set by the call manager.

Re-routing is the changing of the connection path due to any of several reasons such as the mobility of the end-point, failure of nodes in the network or load balancing. In this embodiment, a distinction is made between the re-routing of connections depending on whether the re-routing is done for a leaf or for a root.

To re-route a leaf for example because the route to the leaf from the origin has been changed either because of a failure of nodes in the network or due to the mobility of the leaf itself, the call manager 300:

I. Calculates a new QoS route from the source to the leaf using the procedure (A-E) described above to get the segment to be added to the multi-cast tree. This will be different from the original route from the source to the leaf. Add the new segment to the multicast tree.

II. Drops the old segment that was initially attaching the leaf to the remainder of the multicast tree.

This will complete the re-routing of the leaf.

The algorithm for re-routing a root, because the originating location of the connection has changed its location or otherwise needs to be re-routed, is different from that of re-routing a leaf because if the procedure for re-routing leaves is followed, this will result in a multicast tree that is sub-optimal. This is because when a leave moves, only the connection between the root to that leave is affected. Re-routing a route is different from re-routing a leaf because when the root moves all the connections from the root to all the leaves are affected. In order to overcome this difficulty, the call manager:

1. Moves the root of the connection by applying the procedures above, as if the root were a leaf. It is assumed that the root is just another party of the call, which has to be dropped from its existing position, and added to its new position. A reverse direction must be assumed for the connection so that one of the leaves become a dummy root and the root becomes a dummy leaf, so that the dummy leaf is removed with respect to the dummy root. Having moved the root, an intermediate sub-optimal multicast tree is obtained. The benefit of this approach is the speed with which this re-routing can be achieved. There is no need to search through the entire network for the most appropriate position at which the root is added.

2. The sub-optimal multicast tree that was obtained in phase 1 is optimized to give a tree that is optimal with respect to the optimality criteria. This can be done via one of several methods, for example that disclosed in U.S. Pat. No. 5,291,477.

The advantage of this two-phase approach is that the re-routing can be achieved very fast and can result in a close to optimal multicast tree initially. Then, depending on the resources available in the network, this tree can be optimized offline.

1. Communication apparatus comprising a network of interconnected components having a fixed network portion and at least one wireless network portion, a communication route between a source terminal and a destination terminal being configurable through the network via at least some of the components and a route and location manager arranged to calculate at least one said route, the manager having database means including route-relevant information of the fixed network portion and of the or each wireless network portion.

2. Apparatus as claimed in claim 1 wherein the database means comprises a first database for the information of the first network portion and a second database of the or each wireless network portion.

3. Apparatus as claimed in claim 1 or claim 2 wherein the information of the fixed network comprises node and network topology and Quality of Service information.

4. Apparatus as claimed in any one of claims 1 to 3 wherein the information of the or each wireless network comprises mobile terminal location information.

5. Apparatus as claimed in any one of claims 1 to 4 wherein the information of the or each wireless network comprises Quality of Service information.

6. Apparatus as claimed in any one of the preceding claims wherein the database means is arranged to receive update information from the network.

7. Apparatus as claimed in any one of the preceding claims further comprising a call manager arranged to receive a call request from the source and request a set of routes from the route and location manager in response to the request.

8. Apparatus as claimed in claim 7 wherein the call manager is arranged to set a selected route from the set of routes.

9. Apparatus as claimed in claim 7 or claim 8 further comprising at least one further call manager arranged to receive a further respective call request from a further respective source and obtain a set of routes from the route and location manager in response to the further request.

10. Apparatus as claimed in any one of the preceding claims wherein the route and location manager has an open interface.

11. Apparatus as claimed in any one of the preceding claims wherein the route and location manager is arranged to calculate a route in accordance with the following steps:
a) determining from the database means if the source and/or destination are mobile and if so determining the access point(s) to the fixed network portion; and
b) calculating the set of routes from source to destination using the route-relevant information from the database means using an algorithm.

12. Apparatus as claimed in claim 11 wherein the algorithm is a function of source, destination and Quality of Service.

13. Apparatus as claimed in claim 11 or claim 12 wherein the r oute and location manager is arranged to segment the calculation of the route into mobile and fixed network portions.

14. Apparatus as claimed in claim 13 wherein different Quality of Service parameters are applied (1) to the fixed network portion and (2) to the mobile network portion(s).

15. Apparatus as claimed in claim 14 wherein different Quality of Service parameters are applied to each segment.

16. Apparatus as claimed in any one of claims 13 to 15 wherein different algorithms are applied (1) to the fixed network portion and (2) to the mobile network portions.

17. Apparatus as claimed in claim 16 wherein different algorithms are applied to each segment.

18. A method of adding a further destination to a multicast connection tree between a source and a plurality of destinations comprising the steps of:
a. calculating a set of routes from the source to the further destination without any Quality of Service constraint,
b. selecting the optimal route from the set of routes,
c. calculating a make segment to be added to the existing multicast tree by eliminating the part from the optimal route which is common to the already existing multicast tree, to leave the segment
d. calculating a set of segment routes with a Quality of Service constraint; and
e. selecting the optimal segment route from the set and adding the segment route to the multicast tree.

19. A method as claimed in claim 18 further comprising the step of repeating steps (b)-(e), substituting in step (b) the next most optimal route for the last used route if no segment routes are calculated in step (d) exist.

20. A method as claimed in claim 18 or claim 19 of rerouting a leaf of a multicast tree from an old location to a new location comprising the steps of:
a. calculating a new segment route from the multicast tree to the new location of the leaf in accordance with the method of claim 16 or claim17;
b. adding the new segment route to the multicast tree; and
c. dropping the original segment route from the old location to the remainder of the multicast tree.

21. A method of re-routing a root of a multicast tree from an old location to a new location comprising the steps of:
a. moving the location of the root as if this were a leaf in accordance with the method of claim 20; and
b. optimizing the resultant multicast tree.

22. A method as claimed in claim 21 wherein step (b) is performed offline.

23. Apparatus as claimed in any one of claims 1 to 17 arranged to perform the method of any one of claims 18 to 22.
